(19) United States
(12) Patent Application Publication
(10) Pub. No.: US 2024/0236432 A1
(43) Pub. Date: Jul. 11, 2024

(54) FINE TUNING OF VIDEO DATA IN A STREAMING APPLICATION

(71) Applicant: InterDigital CE Patent Holdings, SAS, Paris (FR)

(72) Inventors: Gaëlle Martin-Cocher, Toronto (CA); Fabrice Le Leannec, Betton (FR); Srinivas Gudumasu, Montreal (CA)

(21) Appl. No.: 18/286,042

(22) PCT Filed: Mar. 29, 2022
(86) PCT No.: PCT/EP2022/058318

§ 371 Date: Oct. 6, 2023

(30) Foreign Application Priority Data
Apr. 8, 2021 (EP) 21305454.7
Oct. 28, 2021 (EP) 21306518.8

(51) Int. Cl. H04N 21/478; A63F 13/355; H04N 19/46; H04N 21/2343; H04N 21/6336

(52) U.S. Cl. CPC H04N 21/4781; A63F 13/355; H04N 19/46; H04N 21/234345; H04N 21/6336

(57) ABSTRACT

A method for fine tuning video data in a low delay streaming application comprising: obtaining an identifier of a quality of experience defining a group of constraint flags involved to obtain the quality of experience, each constraint flag being used to activate or deactivate an associated encoding tool of a video encoder, the identifier specifies a value for each constraint flag indicating an activation or a deactivation of the associated encoding tool; transmitting the identifier to a server; and, receiving a video stream compliant with the identifier from the server.

### 1. TECHNICAL FIELD

At least one of the present embodiments generally relates to methods, apparatuses and signals allowing a fine tuning of video data in a low delay streaming application.

### 2. BACKGROUND

Streaming applications have grown strongly in recent years. While at the beginning, streaming applications were addressing pure audio and/or video applications, they touch now new domains such as the domain of gaming applications. Gaming applications are indeed moving from on device to cloud hosted applications. Cloud gaming allows for partly offloading a game rendering process to some remote game servers situated in a cloud.

FIG. 1A represents schematically a cloud gaming system. Basically, a game engine 10 and a 3D graphics rendering 11, which require costly and power consuming devices, are implemented by a server 1 in the cloud. Generated pictures are then classically encoded in a video stream with a regular/standard video encoder 12 and sent to a user game system 2 via a network 3. The user game system 2 is for example a PC or a game console. We suppose here that the user game system comprises an input device (such as a joypad or a keyboard). The video stream is then decoded on the user game system 2 side with a regular/standard video decoder 20 for rendering on a display device. An additional lightweight module 21, called registration module in the following, is in charge of managing the gamer interaction commands (i.e. in charge of registering user actions).

One key factor for user comfort in gaming applications is a latency called motion-to-photon, i.e. the latency between a user action (motion) and the display of the results of this action on the display device (photon).

FIG. 1B describes schematically a typical motion-to-photon path in a cloud gaming application.

The steps described in relation to FIG. 1B are implemented by the cloud gaming system of FIG. 1A and requires a collaboration between the server 1 and the user game system 2 (i.e. the client system).

In a step 100, on the game system 2 side, a user action is registered by the input device and sent to a main processing module.

In a step 101, information representative of the user action is transmitted to the server 1 via the network 3.

In a step 102, the registered action is used by a game engine 10 to compute a next game state (or next game states). A game state includes a user state (position, etc.), as well as all other entities states which can be either computed by the game engine 10 or external states in case of multi-players games.

In a step 103, from the game state, a picture rendering is computed.

The rendering is followed by a video encoding of the rendered pictures in a video stream by the video encoder 12 in a step 104.

The video stream generated by the video encoder 12 is then transmitted to the user game system 2 via the network 3 in a step 105 and decoded by the video decoder 20 in a step 106.

The resulting pictures are then displayed on a display device in a step 107.

Each of the above steps introduces a processing latency. In FIG. 1B, boxes with a dotted background represents steps introducing a latency due to hardware computations. In general, this latency is fixed, small and cannot be changed easily. Boxes with a white background, represent steps introducing a latency due to software computations. In general, this latency is longer and can be adapted dynamically.

In the motion-to-photon path of FIG. 1B, the encoding and decoding processes introduce significant latencies. However, these latencies are typical latencies that can be adapted dynamically depending on the application constraints or on the user wishes.

Gaming is a domain were users (gamers) are used to tune any parameters made available to them, either to enjoy the game in its highest possible quality or to obtain the most reactive and fast user experience. Gamers are generally trading visual quality for lower game lag. However, in cloud gaming, a quite limited amount of parameters are made available to the end-user. Tools aiming at controlling finely computational cost, latency and rendering of video codecs in cloud gaming applications would be beneficial. Similarly, other application such as head mounted displays (HMD) based applications or augmented reality/virtual reality (AR/VR) glasses based application, and even any low delay streaming applications would benefit of this fine control/tuning of video codecs.

It is desirable to propose solutions allowing to overcome the above issues. In particular, it is desirable to propose a solution allowing a fine tuning of a codec in streaming applications. This solution would be particularly adapted to the cloud gaming context in order to allow gamers finding the best compromise between responsiveness of the game and quality of the display that suits them best.

### 3. BRIEF SUMMARY

In a first aspect, one or more of the present embodiments provide a method comprising: obtaining an identifier of a desired quality of experience defining a group of constraint flags involved to obtain the desired quality of experience, each constraint flag being used to activate or deactivate an associated encoding tool of a video encoder, the identifier specifies a value for each constraint flag indicating an activation or a deactivation of the associated encoding tool: transmitting the identifier to a remote server; and, receiving a video stream compliant with the identifier from the remote server.

In an embodiment, the identifier is further used to define a decoding decision allowing tuning a video decoder so that the video decoder skips at least one decoding process specified in the video stream or the video decoder adds at least one additional decoding process to the decoding processes specified in the video stream.

In an embodiment, the identifier is transmitted using a session description protocol.

In an embodiment, the identifier is obtained after a phase of capability exchange with the remote server comprising a reception from the remote server of a session description protocol message specifying encoding tools that can be activated or deactivated or a set of qualities of experience that can be selected.

In an embodiment, before obtaining the identifier, the method comprises obtaining a description of a set of qualities of experience that can be selected in a SEI message.

In an embodiment, each quality of experience of the set is associated to a corresponding group of constraint flags and/or to at least one encoding decision and/or to at least one decoding decision.

In a second aspect, one or more of the present embodiments provide a method comprising: obtaining an identifier of a desired quality of experience defining a group of constraint flags involved to obtain the desired quality of experience, each constraint flag being used to activate or deactivate an associated encoding tool of a video encoder, the identifier specifies a value for each constraint flag indicating an activation or a deactivation of the associated encoding tool: obtaining a encoded video stream compliant with the identifier; and, transmitting the encoded video stream to a remote system.

In an embodiment, the encoded video stream is obtained by tuning a video encoder based on the identifier.

In an embodiment, the tuning comprises activating or deactivating encoding tools associated with the group of constraint flags in function of the values specified by the identifier.

In an embodiment, the identifier is further used to specify at least one encoding decision allowing defining a particular implementation of a video encoder independently of the constraint flags and any profile.

In an embodiment, the identifier is obtained from the remote system in a session description protocol message.

In an embodiment, the identifier is obtained after a phase of capability exchange with the remote system comprising a transmission to the remote system of a session description protocol message specifying encoding tools that can be activated or deactivated or a set of qualities of experience that can be selected.

In an embodiment, before obtaining the identifier, the method comprises transmitting to the remote system a description of a set of qualities of experience that can be selected in a SEI message.

In an embodiment, each quality of experience of the set is associated to a corresponding group of constraint flags and/or to at least one encoding decision and/or to at least one decoding decision.

In a third aspect, one or more of the present embodiments provide a signal comprising an identifier of a desired quality of experience defining a group of constraint flags involved to obtain the desired quality of experience, each constraint flag being used to activate or deactivate an associated encoding tool of a video encoder, the identifier specifies a value for each constraint flag indicating an activation or a deactivation of the associated encoding tool.

In a fourth aspect, one or more of the present embodiments provide a device comprising an electronic circuitry adapted for: obtaining an identifier of a desired quality of experience defining a group of constraint flags involved to obtain the desired quality of experience, each constraint flag being used to activate or deactivate an associated encoding tool of a video encoder, the identifier specifies a value for each constraint flag indicating an activation or a deactivation of the associated encoding tool; transmitting the identifier to a remote server: and, receiving a video stream compliant with the identifier from the remote server.

In an embodiment, the identifier is further used to define a decoding decision allowing tuning a video decoder so that the video decoder skips at least one decoding process specified in the video stream or the video decoder adds at least one additional decoding process to the decoding processes specified in the video stream.

In an embodiment, the identifier is transmitted using a session description protocol.

In an embodiment, the identifier is obtained after a phase of capability exchange with the remote server comprising a reception from the remote server of a session description protocol message specifying encoding tools that can be activated or deactivated or a set of qualities of experience that can be selected.

In an embodiment, the electronic circuitry is further adapted for obtaining a description of a set of qualities of experience that can be selected in a SEI message before obtaining the identifier.

In an embodiment, each quality of experience of the set is associated to a corresponding group of constraint flags and/or to at least one encoding decision and/or to at least one decoding decision.

In a fifth aspect, one or more of the present embodiments provide a device comprising an electronic circuitry adapted for: obtaining an identifier of a desired quality of experience defining a group of constraint flags involved to obtain the desired quality of experience, each constraint flag being used to activate or deactivate an associated encoding tool of a video encoder, the identifier specifies a value for each constraint flag indicating an activation or a deactivation of the associated encoding tool: obtaining a encoded video stream compliant with the identifier: and, transmitting the encoded video stream to a remote system.

In an embodiment, the encoded video stream is obtained by tuning a video encoder based on the identifier.

In an embodiment, the tuning comprises activating or deactivating encoding tools associated with the group of constraint flags in function of the values specified by the identifier.

In an embodiment, the identifier is further used to specify at least one encoding decision allowing defining a particular implementation of a video encoder independently of the constraint flags and any profile.

In an embodiment, the identifier is obtained from the remote system in a session description protocol message.

In an embodiment, the identifier is obtained after a phase of capability exchange with the remote system comprising a transmission to the remote system of a session description protocol message specifying encoding tools that can be activated or deactivated or a set of qualities of experience that can be selected.

In an embodiment, before obtaining the identifier, the method comprises transmitting to the remote system a description of a set of qualities of experience that can be selected in a SEI message.

In an embodiment, each quality of experience of the set is associated to a corresponding group of constraint flags and/or to at least one encoding decision and/or to at least one decoding decision.

In a sixth aspect, one or more of the present embodiments provide a computer program comprising program code instructions for implementing the method according to the first or the second aspect.

In a seventh aspect, one or more of the present embodiments provide a non-transitory information storage medium storing program code instructions for implementing the method according to the first or the second aspect.

### 4. BRIEF SUMMARY OF THE DRAWINGS

FIG. 1A describes an example of a context in which embodiments can be implemented;

FIG. 1B illustrates the concept of motion-to-photon path:

FIG. 2 illustrates schematically a first embodiment of a method allowing fine tuning of a codec in a streaming application;

FIG. 3 depicts schematically a second embodiment of a method allowing fine tuning of a codec in a streaming application;

FIG. 4 depicts schematically a third embodiment of a method allowing fine tuning of a codec in a streaming application:

FIG. 5A illustrates schematically an example of hardware architecture of a processing module in which various aspects and embodiments are implemented:

FIG. 5B illustrates a block diagram of an example of a game system in which various aspects and embodiments are implemented:

FIG. 5C illustrates a block diagram of an example of a server in which various aspects and embodiments are implemented;

FIG. 6 illustrates an example of partitioning undergone by a picture of pixels of an original video;

FIG. 7 depicts schematically a method for encoding a video stream executed by an encoding module:

FIG. 8 depicts schematically a method for decoding a video stream executed by a decoding module: and,

FIG. 9 illustrates a streaming session establishment process between a client and a server using a RTP/RTSP session-based streaming according to the an embodiment.

### 5. DETAILED DESCRIPTION

In the following, we present examples of embodiments allowing fine tuning of codecs in streaming application, these solutions being particularly adapted to low delay streaming applications such as the cloud gaming applications. In the context of streaming and/or gaming, one can mention the following tuning solutions:
Adjustment of device and network settings: Examples of device settings commonly adjusted by gamers are: updating graphic card drivers, disabling native graphic card when a more performant one is available on the device, optimizing hardware (PC and Routers), connecting to Ethernet rather than WiFi, adjusting router parameters, changing networks, selecting servers closer to the user.
Adjustment of in game settings: Example of in-game settings that can be adjusted (generally to increase the number of frame per second (fps)):
   Lowering resolution;
   Lowering the amount of details in pictures;
   Disabling or changing anti-aliasing, motion blur modes and other advanced rendering parameters which may be performed on a device.
Developer settings: Tools are emerging to monitor the gamer experience for the game developer to adapt its game and development. Fps and CPU usage on devices are tracked and aggregated based on annotation (anchors) integrated in the game play by the developer. An example of such tool is the Android Performance Tuner as described in https://developer.android.com/games/sdk/performance-tuner.
Video codec profile: A video codec profile defines a fixed set of tools that may be used by a video encoder and that shall be supported by a video decoder. These profiles are useful to ensure interoperability of devices across a multitude of services. In closed OTT (Over The Top) ecosystem, a private codec or private profile could be loaded with the application on a endpoint. However, the interoperability with other services is not a requirement and it comes at a computational cost on the end device which does not benefit from hardware implementation and that could be a disincentive or even a technical burden for demanding applications such as cloud gaming.
VVC flags: In a recent video codec called VVC (H.266, ISO/IEC 23090-3, MPEG-I Part 3 (Versatile Video Coding)), coding tools can be enabled/disabled by high level syntax elements (called constraint flags), to indicate that a particular encoding tool was not used by an encoder for a given bitstream. In VVC, constraints flags are gathered in a data structure called general_constraints_info. With this, a bitstream can be labelled as not using certain tools, which allows among other things for resource allocation in a decoder implementation.
Capability exchanges: For streaming services and file download, an exchange of multimedia capability information takes place between a end-device and a server. This allows to tailor a content to a device and/or to network capabilities by use of Quality Of Experience (QoE). These device capability information are usually specified as part of handshake protocols and transport protocol format. For instance:
   3GPP TS 23.234 “Transparent end-to-end Packet-switched Streaming Service (PSS)” specifies a session establishment process where device capabilities are exchanged and followed by an SDP (session description protocols) based communication which enables servers to provide a wide range of devices with content suitable for these devices. However, these exchanges of capability information are not related to the VVC constraints flag, nor to desired user quality of experience settings.
   The 3GPP SA4 MTSI specification (TS 26.114) uses RTP (Real-Time Transport Protocol) to transport media data, and SDP mechanism defined in RTP/AVPF (RFC4585) and SDPCapNeg (RFC 5939). There is no to little information exchange related to a desired user quality of experience.
   The 3GPP 5GMS specification (5G multimedia Streaming) rely on MPEG DASH (Dynamic Adaptive Streaming over HTTP/ISO/IEC 23009-1:201x) or the ISO file format for transmitting the media over HTTP(s). Hence, while content selection can be tuned, the use of these transport protocol in the 5GMS specs, are at the moment not suited for fine tuning of codecs low in latency applications such as gaming applications.

As seen above with the video codec profiles and the constraint flags, solutions exist for controlling a codec. However, in their current form, these solutions are not adapted for allowing a user to fine tune a codec in a low delay streaming application such as a cloud gaming application.

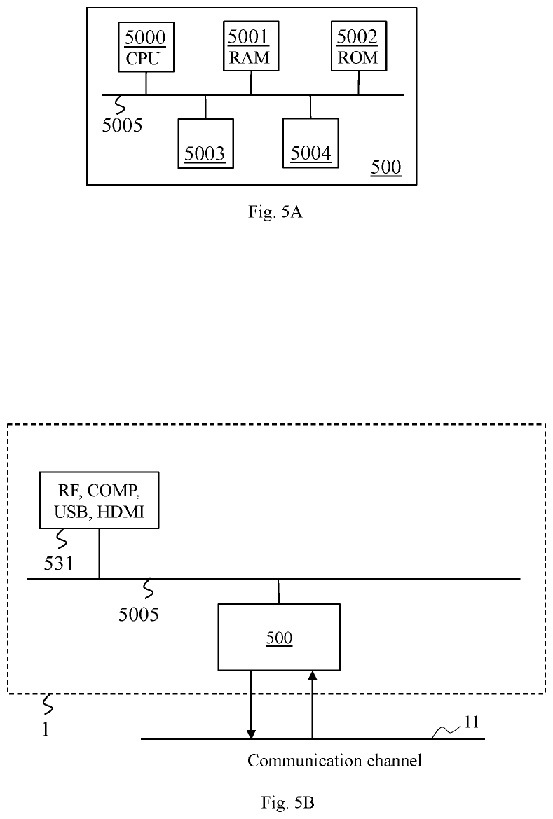

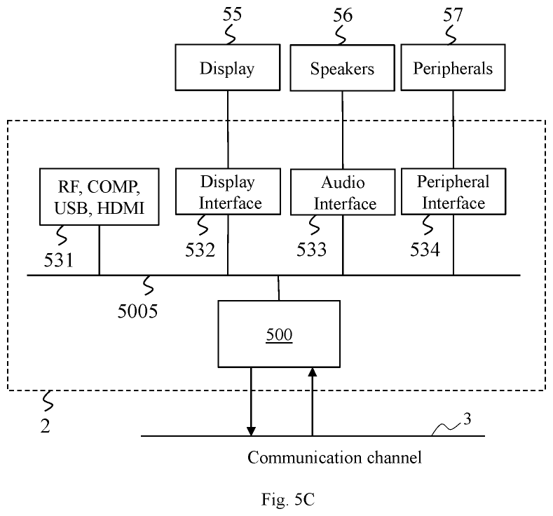

FIG. 5A illustrates schematically an example of hardware architecture of a processing module 500 able to implement modules of the server 1 such as for example the video encoder 12 and/or the game engine 10 and/or the 3D graphics renderer 11 or modules of the game system 2 such as for example, the video decoder 20 and/or the registration module 21.

The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples: a random access memory (RAM) 5001: a read only memory (ROM) 5002: a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device: at least one communication interface 5004 for exchanging data with other modules, devices or equipment. The communication interface 5004 can include, but is not limited to, a transceiver configured to transmit and to receive data over a communication channel (or network) 3. The communication interface 5004 can include, but is not limited to, a modem or network card.

If the processing module 500 implements the video decoder 20, the communication interface 5004 enables for instance the processing module 500 to receive encoded video streams and to provide a sequence of decoded pictures.

If the processing module 500 implements the registration module 21, the communication interface 5004 enables for instance the processing module 500 to receive user actions or parameters selected by a user and to provide data representative of these user actions and parameters to the game engine 10 and/or to the video decoder 20.

If the processing module 500 implements the video encoder 12, the communication interface 5004 enables for instance the processing module 500 to receive pictures generated by the 3D graphics renderer 11 and to provide an encoded video stream representative of these pictures.

If the processing module 500 implements the game engine 10, the communication interface 5004 enables for instance the processing module 500 to receive data representative of the user actions and selected parameters and to provide these data to the 3D graphics renderer and/or to the video encoder 12.

If the processing module 500 implements the 3D graphics renderer 11, the communication interface 5004 enables for instance the processing module 500 to receive data representative of the user actions and/or selected parameters so that it can generate corresponding pictures and to transmit the generated pictures to the video encoder 12.

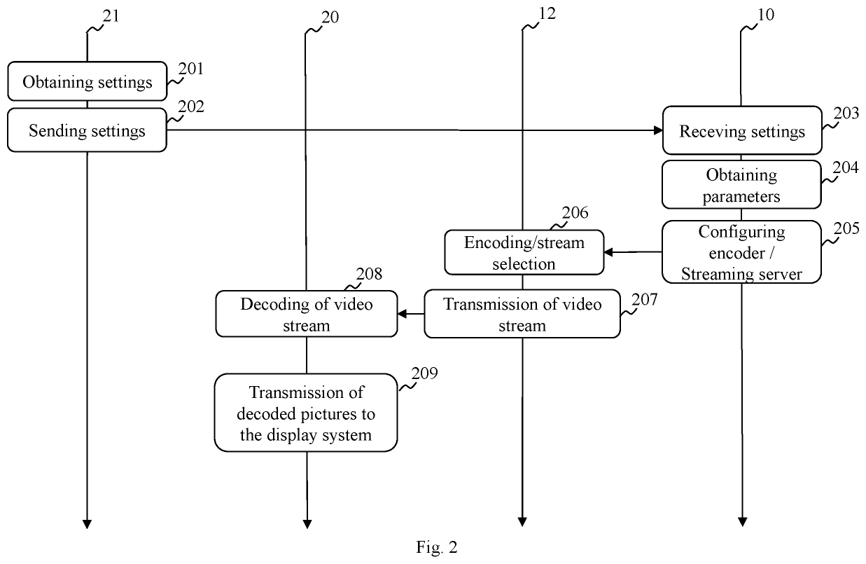

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method, an encoding method, processes executed by the game engine 10, the 3D graphics renderer 11, the registration module 21 and parts of processes described in relation to FIGS. 2, 3 and 4 described below in this document.

All or some of the algorithms and steps of said encoding or decoding methods may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

FIG. 5C illustrates a block diagram of an example of the game system 2 in which various aspects and embodiments are implemented. The game system 2 can be embodied as a device including the various components described above (i.e. the registration module 21 and the video decoder 20) and is configured to perform one or more of the aspects and embodiments described in this document. Examples of such devices include, but are not limited to, various electronic devices such as personal computers, laptop computers, smartphones, tablet computers, head mounted display and a game console. Elements of game system 2, singly or in combination, can be embodied in a single integrated circuit (IC), multiple ICs, and/or discrete components. For example, in at least one embodiment, the game system 2 comprises one processing module 500 that implements the video decoder 20 and the registration module 21. In various embodiments, the game system 2 is communicatively coupled to one or more other systems, or other electronic devices, via, for example, a communications bus or through dedicated input and/or output ports. In various embodiments, the game system 2 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Various elements of game system 2 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the game system 2, the processing module 500 is interconnected to other elements of said game system 2 by the bus 5005.

The communication interface 5004 of the processing module 500 allows the game system 2 to communicate on the communication channel 3. As already mentioned above, the communication channel 3 can be implemented, for example, within a wired and/or a wireless medium.

Data is streamed, or otherwise provided, to the game system 2, in various embodiments, using a wireless network such as a Wi-Fi network, for example IEEE 802.11 (IEEE refers to the Institute of Electrical and Electronics Engineers). The Wi-Fi signal of these embodiments is received over the communications channel 3 and the communications interface 5004 which are adapted for Wi-Fi communications. The communications channel 3 of these embodiments is typically connected to an access point or router that provides access to external networks including the Internet for allowing streaming applications and other over-the-top communications. Other embodiments provide streamed data to the game system 2 using the RF connection of the input block 531. Additionally, various embodiments use wireless networks other than Wi-Fi, for example a cellular network.

The game system 2 can provide an output signal to various output devices, including a display system 55, speakers 56, and other peripheral devices 57. The display system 55 of various embodiments includes one or more of, for example, a touchscreen display, an organic light-emitting diode (OLED) display, a curved display, and/or a foldable display. The display system 55 can be for a television, a tablet, a laptop, a cell phone (mobile phone), a head mounted display or other devices. The display system 55 can also be integrated with other components, for example, as in a smart phone, or separate, for example, an external monitor for a laptop. The other peripheral devices 57 include, in various examples of embodiments, one or more of a stand-alone digital video disc (or digital versatile disc) (DVR, for both terms), a disk player, a stereo system, and/or a lighting system. Various embodiments use one or more peripheral devices 57 that provide a function based on the output of the game system 2. For example, a disk player performs the function of playing an output of the game system 2.

In various embodiments, control signals are communicated between the game system 2 and the display system 55, speakers 56, or other peripheral devices 57 using signaling such as AV.Link, Consumer Electronics Control (CEC), or other communications protocols that enable device-to-device control with or without user intervention. The output devices can be communicatively coupled to game system 2 via dedicated connections through respective interfaces 532, 533, and 534. Alternatively, the output devices can be connected to game system 2 using the communications channel 3 via the communications interface 5004 or a dedicated communication channel via the communication interface 5004. The display system 55 and speakers 56 can be integrated in a single unit with the other components of game system 2 in an electronic device such as, for example, a game console. In various embodiments, the display interface 532 includes a display driver, such as, for example, a timing controller (T Con) chip.

The display system 55 and speaker 56 can alternatively be separate from one or more of the other components. In various embodiments in which the display system 55 and speakers 56 are external components, the output signal can be provided via dedicated output connections, including, for example, HDMI ports, USB ports, or COMP outputs.

FIG. 5B illustrates a block diagram of an example of the server 1 in which various aspects and embodiments are implemented. Server 1 is very similar to the game system 2. The server 1 can be embodied as a device including the various components described above (i.e. the game engine 10, the 3D graphics renderer 11 and the video encoder 12) and is configured to perform one or more of the aspects and embodiments described in this document. Examples of such devices include, but are not limited to, various electronic devices such as personal computers, laptop computers and a server. Elements of server 1, singly or in combination, can be embodied in a single integrated circuit (IC), multiple ICs, and/or discrete components. For example, in at least one embodiment, the server 1 comprises one processing module 500 that implements the video encoder 12, the 3D graphics renderer 11 and the game engine 10. In various embodiments, the server 1 is communicatively coupled to one or more other systems, or other electronic devices, via, for example, a communications bus or through dedicated input and/or output ports. In various embodiments, the server 1 is configured to implement one or more of the aspects described in this document.

The input to the processing module 500 can be provided through various input modules as indicated in block 531 already described in relation to FIG. 5C.

Various elements of server 1 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the server 1, the processing module 500 is interconnected to other elements of said server 1 by the bus 5005.

The communication interface 5004 of the processing module 500 allows the server 1 to communicate on the communication channel 3.

Data is streamed, or otherwise provided, to the server 1, in various embodiments, using a wireless network such as a Wi-Fi network, for example IEEE 802.11 (IEEE refers to the Institute of Electrical and Electronics Engineers). The Wi-Fi signal of these embodiments is received over the communications channel 3 and the communications interface 5004 which are adapted for Wi-Fi communications. The communications channel 3 of these embodiments is typically connected to an access point or router that provides access to external networks including the Internet for allowing streaming applications and other over-the-top communications. Other embodiments provide data to the server 1 using the RF connection of the input block 531.

Various embodiments use wireless networks other than Wi-Fi, for example a cellular network.

The data provided to the server 1 are the data representative of actions performed by the user (or users) or parameters selected by the user (or users).

The server 1 provide an encoded video stream in the form of an output signal to the game system 2.

Various implementations involve decoding. “Decoding”, as used in this application, comprises applying a decoding process to an encoded video stream in function of encoding tools that are activated or deactivated in the encoded video stream but also, in some embodiments, in function of tuning parameter defining a particular implementation of the decoding process.

Various implementations involve encoding. “Encoding” as used in this application comprises applying an encoding process in function of encoding tools selected by the user, but also, in some embodiments, in function of tuning parameter defining a particular implementation of the encoding process.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream comprising constraints flags in a data structure general_constraints_info. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

The following examples of embodiments are described in the context of a video format similar to VVC. However, these embodiments are not limited to the video coding/decoding method corresponding to VVC. These embodiments are in particular adapted to any video format in which encoding tools can be activated, deactivated or modified or as soon as a particular implementation of an encoder or of a decoder can be selected. Such formats comprise for example the standard EVC (Essential Video Coding/MPEG-5), AV1 and VP9.

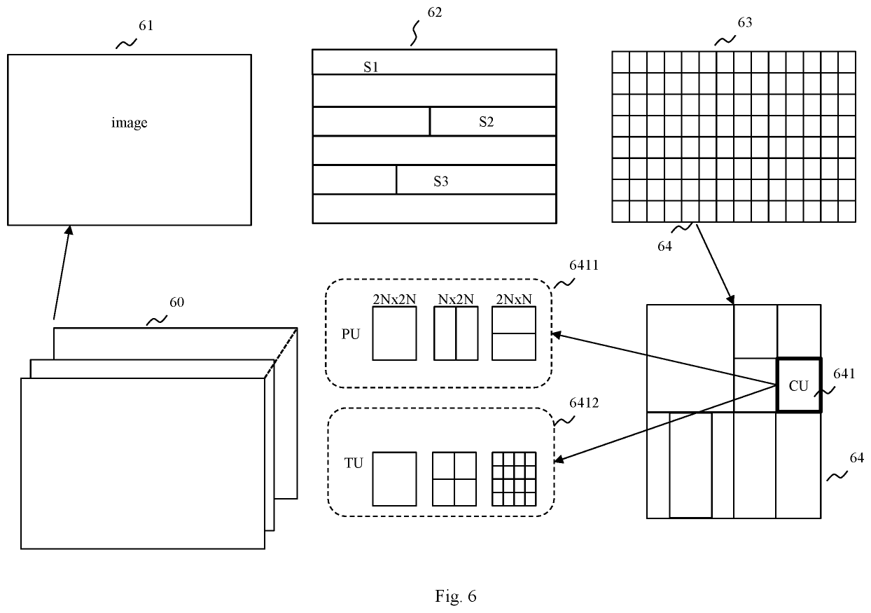

FIGS. 6, 7 and 8 introduce an example of video format.

FIG. 6 illustrates an example of partitioning undergone by a picture of pixels 61 of an original sequence of pictures 60. It is considered here that a pixel is composed of three components: a luminance component and two chrominance components. Other types of pixels are however possible comprising less or more components such as only a luminance component or an additional depth component.

A picture is divided into a plurality of coding entities. First, as represented by reference 63 in FIG. 6, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. A particular type of tile prevent spatial and temporal predictions from samples from other tiles. These tiles are called subpictures. Above the concept of tiles and bricks, another encoding entity, called slice, exists, that can contain at least one tile of a picture or at least one brick of a tile.

In the example in FIG. 6, as represented by reference 62, the picture 61 is divided into three slices S1, S2 and S3 of the raster-scan slice mode, each comprising a plurality of tiles (not represented), each tile comprising only one brick.

As represented by reference 64 in FIG. 6, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 6, the CTU 14 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 6, a CU of size 2N×2N, can be divided in PU 6411 of size N×2N or of size 2N×N. In addition, said CU can be divided in “4” TU 6412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “subpicture”, “slice” and “frame” may be used interchangeably. Usually, but not necessarily, the term “reconstructed” is used at the encoder side while “decoded” is used at the decoder side.

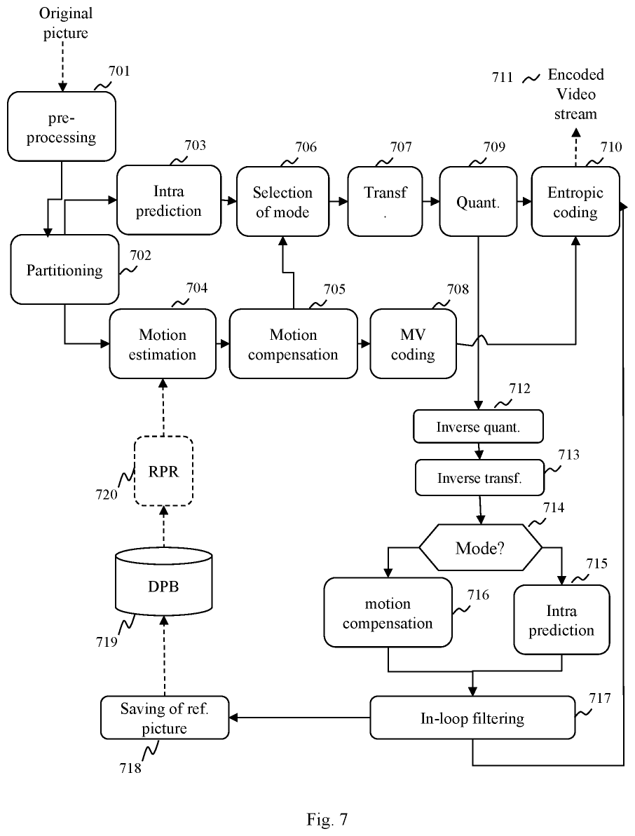

FIG. 7 depicts schematically a method for encoding a video stream executed by an encoding module. Variations of this method for encoding are contemplated, but the method for encoding of FIG. 7 is described below for purposes of clarity without describing all expected variations. All steps described in relation to FIG. 7 are for example executed by the processing module 500 when this processing module implements the video encoder 12.

Before being encoded, a current original image of an original video sequence may go through a pre-processing. For example, in a step 701, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). In addition, the pre-processing 601 may comprise a resampling (a down-sampling or an up-sampling). The resampling may be applied to some pictures so that the generated bitstream may comprise pictures at the original resolution and picture at another resolution (or at least pictures at least two different resolutions). The resampling consists generally in a down-sampling and is used to reduce the bitrate of the generated bitstream. Nevertheless, up-sampling is also possible. Pictures obtained by pre-processing are called pre-processed pictures in the following.

The encoding of the pre-processed pictures begins with a partitioning of the pre-processed picture during a step 702, as described in relation to FIG. 6. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 703, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block. Recently, new intra prediction mode were proposed and introduced in VVC. These new intra prediction modes comprises
MIP (Matrix weighted Intra Prediction) consisting in using a matrix for generating an intra predictor from reconstructed neighbouring boundary samples on the left and above the block to predict;
ISP (Intra Sub-Partitions) dividing luma intra-predicted blocks vertically or horizontally into 2 or 4 sub-partitions depending on the block size;
CCLM (Cross-component linear model) prediction wherein the chroma samples of a CU are predicted based on the reconstructed luma samples of the same CU by using a linear model;
IBC (Intra Block Copy) consisting in predicting a block in a picture from another block of the same picture: and,
Reference samples filtering in intra area consisting in filtering reference samples used for intra prediction.

The inter prediction consists of predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 704. During step 704, a motion vector indicating the position of the reference block in the reference picture is determined. The motion estimation is generally performed at a sub-pixel precision, i.e. current and reference pictures are interpolated. The motion vector determined by the motion estimation is used during a motion compensation step 305 during which a residual block is calculated in the form of a difference between the current block and the reference block.

In first video compression standards, the mono-directional inter prediction mode described above was the only inter mode available. As video compression standards evolve, the family of inter modes has grown significantly and comprises now many different inter modes. These inter prediction modes comprises for example:
DMVR (decoder side motion vector refinement) wherein, in bi-prediction, a refined motion vector is searched around each initial motion vector. The refinement is performed symmetrically by the encoder and the decoder.
BDOF (bi-directional optical flow) which is based on the optical flow concept, which assumes that the motion of an object is smooth. BDOF is used to refine the bi-prediction signal of a CU at the 4×4 subblock level. BDOF is only applied to the luma component.
PROF (prediction refinement with optical flow): Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation.
CIIP (Combined inter and intra prediction) which combines an inter prediction signal with an intra prediction signal.
GPM (geometric partitioning mode) which splits a CU into two parts by a geometrically located straight line. Each part of a geometric partition in the CU is inter-predicted using its own motion: only uni-prediction is allowed for each partition.

During a selection step 706, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 707 and quantized during a step 709. Transformation has also evolved and new tools were recently proposed. These new tools comprises:
JCCR (Joint coding of chroma residuals) where the chroma residuals are coded jointly
MTS (multiple transform selection) where a selection is performed between a DCT-2, a DST-7 and a DCT-8 for horizontal and vertical transforms.
LFNST (Low-frequency non-separable transform): LFNST is applied between forward primary transform and quantization (at encoder) and between de-quantization and inverse primary transform (at decoder side). A 4×4 non-separable transform or a 8×8 non-separable transform is applied according to block size.
BDPCM (Block differential pulse coded modulation). BDPCM can be viewed as a competitor of the regular intra mode. When BDPCM is used, a BDPCM prediction direction flag is transmitted to indicate whether the prediction is horizontal or vertical. Then, the block is predicted using the regular horizontal or vertical intra prediction process with unfiltered reference samples. The residual is quantized and the difference between each quantized residual and its predictor, i.e. the previously coded residual of the horizontal or vertical (depending on the BDPCM prediction direction) neighbouring position, is coded.
SBT (Subblock transform) in which only a sub-part of the residual block is coded for the CU.

Note that the encoding module can skip the transform and apply quantization directly to the non-transformed residual signal. When the current block is coded according to an intra prediction mode, a prediction direction and the transformed and quantized residual block are encoded by an entropic encoder during a step 710. When the current block is encoded according to an inter prediction, when appropriate, a motion vector of the block is predicted from a prediction vector selected from a set of motion vectors corresponding to reconstructed blocks situated in the vicinity of the block to be coded. The motion information is next encoded by the entropic encoder during step 710 in the form of a motion residual and an index for identifying the prediction vector. The transformed and quantized residual block is encoded by the entropic encoder during step 710. Note that the encoding module can bypass both transform and quantization, i.e., the entropic encoding is applied on the residual without the application of the transform or quantization processes. The result of the entropic encoding is inserted in an encoded video stream 711.

After the quantization step 709, the current block is reconstructed so that the pixels corresponding to that block can be used for future predictions. This reconstruction phase is also referred to as a prediction loop. An inverse quantization is therefore applied to the transformed and quantized residual block during a step 712 and an inverse transformation is applied during a step 713. According to the prediction mode used for the block obtained during a step 714, the prediction block of the block is reconstructed. If the current block is encoded according to an inter prediction mode, the encoding module applies, when appropriate, during a step 716, a motion compensation using the motion vector of the current block in order to identify the reference block of the current block. If the current block is encoded according to an intra prediction mode, during a step 715, the prediction direction corresponding to the current block is used for reconstructing the reference block of the current block. The reference block and the reconstructed residual block are added in order to obtain the reconstructed current block.

Following the reconstruction, an in-loop filtering intended to reduce the encoding artefacts is applied, during a step 717, to the reconstructed block. This filtering is called in-loop filtering since this filtering occurs in the prediction loop to obtain at the decoder the same reference images as the encoder and thus avoid a drift between the encoding and the decoding processes. As mentioned earlier, in-loop filtering tools comprises deblocking filtering. SAO (Sample Adaptive Offset), ALF

(Adaptive Loop Filter) and CC-ALF (Cross Component ALF). CC-ALF uses luma sample values to refine each chroma component by applying an adaptive, linear filter to the luma channel and then using the output of this filtering operation for chroma refinement. A new tool called LMCS (Luma Mapping with Chroma Scaling) can be also considered as an in-loop filtering. LMCS is added as a new processing block before the other loop-filters. LMCS has two main components: in-loop mapping of the luma component based on adaptive piecewise linear models: for the chroma components, luma-dependent chroma residual scaling is applied.

When a block is reconstructed, it is inserted during a step 718 into a reconstructed picture stored in a memory 719 of reconstructed images corresponding generally called Decoded Picture Buffer (DPB). The reconstructed images thus stored can then serve as reference images for other images to be coded.

A new tool of VVC, called Reference Picture Resampling (RPR), allows changing the resolution of coded pictures on the fly. The pictures are stored in the DPB, at their actual coded/decoded resolution, which may be lower that the video spatial resolution signalled in high-level syntax (HLS) of the bitstream. When a picture being coded at a given resolution uses for temporal prediction a reference picture that is not at the same resolution, a reference picture resampling of the texture is applied so that the predicted picture and the reference picture have the same resolution (represented by step 720 in FIG. 7). Note that depending on the implementation, the resampling process is not necessarily applied to the entire reference picture (entire reference picture resampling) but can be applied only to blocks identified as reference blocks when performing the decoding and reconstruction of the current picture (block-based reference picture resampling). In this case, when a current block in the current picture uses a reference picture that has a different resolution than the current picture, the samples in the reference picture that are used for the temporal prediction of the current block are resampled according to resampling ratios computed as ratios between the current picture resolution and the reference picture resolution.

Metadata such as SEI (supplemental enhancement information) messages can be attached to the encoded video stream 311. A SEI (Supplemental Enhancement Information) message as defined for example in standards such as AVC, HEVC or VVC is a data container or data structure associated to a video stream and comprising metadata providing information relative to the video stream.

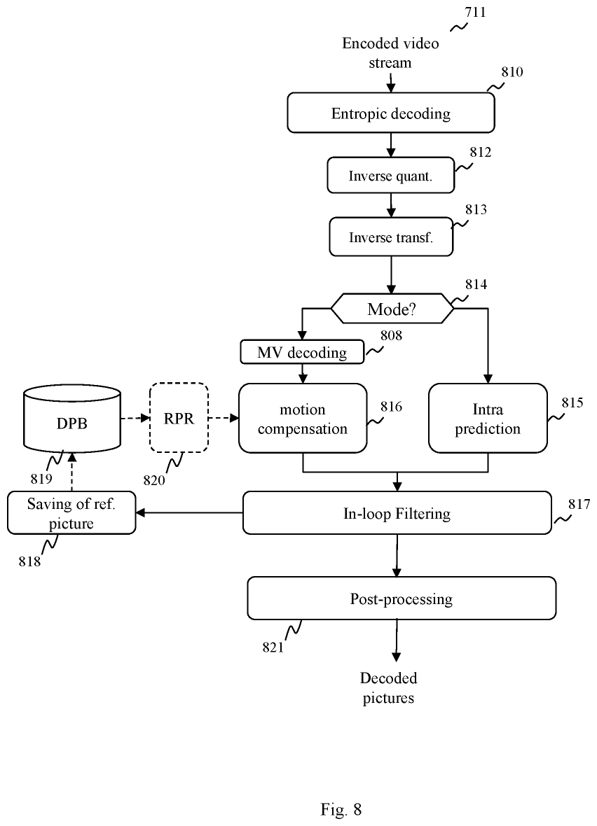

FIG. 8 depicts schematically a method for decoding the encoded video stream 711 encoded according to method described in relation to FIG. 8 executed by a decoding module. Variations of this method for decoding are contemplated, but the method for decoding of FIG. 8 is described below for purposes of clarity without describing all expected variations. All steps described in relation to FIG. 8 are for example executed by the processing module 500 when this processing module implements the video decoder 20.

The decoding is done block by block. For a current block, it starts with an entropic decoding of the current block during a step 810. Entropic decoding allows to obtain the prediction mode of the block.

If the block has been encoded according to an inter prediction mode, the entropic decoding allows to obtain, when appropriate, a prediction vector index, a motion residual and a residual block. During a step 808, a motion vector is reconstructed for the current block using the prediction vector index and the motion residual.

If the block has been encoded according to an intra prediction mode, entropic decoding allows to obtain a prediction direction and a residual block. Steps 812, 813, 814, 815, 816 and 817 implemented by the decoding module are in all respects identical respectively to steps 712, 713, 714, 715, 716 and 717 implemented by the encoding module. Decoded blocks are saved in decoded pictures and the decoded pictures are stored in a DPB 819 in a step 818. When the decoding module decodes a given picture, the pictures stored in the DPB 819 are identical to the pictures stored in the DPB 719 by the encoding module during the encoding of said given image. The decoded picture can also be outputted by the decoding module for instance to be displayed. When RPR is activated, samples of (i.e. at least a portion of) the picture used as reference pictures are resampled in step 820 to the resolution of the predicted picture. The resampling step (820) and motion compensation step (816) can be in some implementations combined in one single sample interpolation step.

The decoded image can further go through post-processing in step 821. The post-processing can comprise an inverse color transform (e.g. conversion from YCbCr 4:2:0 to RGB 4:4:4), an inverse mapping performing the inverse of the remapping process performed in the pre-processing of step 701, a post-filtering for improving the reconstructed pictures based for example on filter parameters provided in a SEI message and/or a resampling for example for adjusting the output images to display constraints.

As mentioned earlier, many encoding tools defined in the encoding method of VVC can be activated or deactivated using constraints flags stored in the data structure general_constraint info as represented in table TAB1.

TABLE 1

```
general_constraints_info( ) {
  gci_present_flag
  if( gci_present_flag ) {
  /* general */
    gci_intra_only_constraint_flag
    gci_all_layers_independent_constraint_flag
    gci_one_au_only_constraint_flag
  /* picture format */
    gci_sixteen_minus_max_bitdepth_constraint_idc
    gci_three_minus_max_chroma_format_constraint_idc
  /* NAL unit type related */
    gci_no_mixed_nalu_types_in_pic_constraint_flag
    gci_no_trail_constraint_flag
    gci_no_stsa_constraint_flag
    gci_no_rasl_constraint_flag
    gci_no_radl_constraint_flag
    gci_no_idr_constraint_flag
    gci_no_cra_constraint_flag
    gci_no_gdr_constraint_flag
    gci_no_aps_constraint_flag
    gci_no_idr_rpl_constraint_flag
  /* tile, slice, subpicture partitioning */
    gci_one_tile_per_pic_constraint_flag
    gci_pic_header_in_slice_header_constraint_flag
    gci_one_slice_per_pic_constraint_flag
    gci_no_rectangular_slice_constraint_flag
    gci_one_slice_per_subpic_constraint_flag
    gci_no_subpic_info_constraint_flag
  /* CTU and block partitioning */
    gci_three_minus_max_log2_ctu_size_constraint idc
    gci_no_partition_constraints_override_constraint_flag
    gci_no_mtt_constraint_flag
    gci_no_qtbtt_dual_tree_intra_constraint_flag
  /* intra */
    gci_no_palette_constraint_flag
    gci_no_ibc_constraint_flag
    gci_no_isp_constraint_flag
    gci_no_mrl_constraint_flag
    gci_no_mip_constraint_flag
    gci_no_cclm_constraint_flag
  /* inter */
    gci_no_ref_pic_resampling_constraint_flag
    gci_no_res_change_in_clvs_constraint_flag
    gci_no_weighted_prediction_constraint_flag
    gci_no_ref_wraparound_constraint_flag
    gci_no_temporal_mvp_constraint_flag
    gci_no_sbtmvp_constraint_flag
    gci_no_amvr_constraint_flag
    gci_no_bdof_constraint_flag
    gci_no_smvd_constraint_flag
    gci_no_dmvr_constraint_flag
    gci_no_mmvd_constraint_flag
    gci_no_affine_motion_constraint flag
    gci_no_prof_constraint_flag
    gci_no_bcw_constraint_flag
    gci_no_ciip_constraint_flag
    gci_no_gpm_constraint_flag
  /* transform, quantization, residual */
    gci_no_luma_transform_size_64_constraint flag
    gci_no_transform_skip_constraint_flag
    gci_no_bdpcm_constraint_flag
    gci_no_mts_constraint_flag
    gci_no_lfnst_constraint flag
    gci_no_joint_cbcr_constraint_flag
    gci_no_sbt_constraint_flag
    gci_no_act_constraint_flag
    gci_no_explicit_scaling_list_constraint_flag
    gci_no_dep_quant_constraint_flag
    gci_no_sign_data_hiding_constraint_flag
    gci_no_cu_qp_delta_constraint_flag
    gci_no_chroma_qp_offset_constraint_flag
  /* loop filter */
    gci_no_sao_constraint_flag
    gci_no_alf_constraint_flag
    gci_no_ccalf_constraint_flag
    gci_no_lmcs_constraint_flag
    gci_no_ladf constraint_flag
    gci_no_virtual_boundaries_constraint_flag
    gci_num_reserved bits
    for( i = 0; i < gci_num_reserved_bits; i++ )
      gci_reserved_zero_bit[ i]
  }
  while( !byte_aligned( ) )
    gci_alignment_zero_bit
}
```

For instance:
The constraint flag gci_no_mip_constraint_flag activates or deactivates MIP;
The constraint flag gci_no_isp_constraint_flag activates or deactivates ISP;
The constraint flag gci_no_dmvr_constraint_flag activates of deactivates DMVR;
The constraint flag gci_no_bdof_constraint_flag activates or deactivates BDOF;
The constraint flag gci_no_mts_constraint_flag activates or deactivates MTS;
The constraint flag gci_no_Ifnst_constraint_flag activates or deactivates LFNST;
The constraint flag gci_no_sao_constraint_flag activates or deactivates SAO;
Etc.

FIG. 2 illustrates schematically a first embodiment of a method allowing fine tuning of a codec in a streaming application.

The method of FIG. 2 is implemented by the server 1 and the game system 2. However, this method can be implemented out of the gaming context, by any system implementing a low latency streaming application.

In FIG. 2, only modules involved in the fine tuning of the codec are represented, i.e. the game engine 10, the video encoder 12, the video decoder 20 and the game registration module 21. For simplification, the 3D graphics renderer 11, which is only involved in the generation of the original pictures that are provided to the video encoder 12, is not represented. However, all pictures encoded by the video encoder 12 and decoded by the video decoder 20 were originally generated by the 3D graphics renderer 11 under the control of the game engine 10.

The game engine 10 is a typical module of a gaming application. In other type of low delay streaming applications (video conferencing, applications based on head mounted displays (HMD) or augmented reality/virtual reality (AR/VR) glasses based application XR on glasses, any immersive and interactive applications), the game engine 10 is replaced by a simpler module at least in charge of collecting data representative of encoding parameters and to configure the video encoder 12 based on these encoding parameters.

Similarly, in other types of low delay streaming applications, the registration module 21 collects parameters representative of a desired quality of experience (QoE) originating from a user, in some embodiments translates these parameters representative of a desired QoE in encoding parameters, and forward the parameters representative of a desired QoE or the encoding parameters to the server 1.

When starting a game application or any low latency streaming application, the user can access parameters from a user interface and select some settings according to his desired QoE. These settings can be described by a generic label or could be quite detailed.

In FIG. 2, for simplification, we suppose that a processing module 500 implements all modules of the server 1 and another processing module 500 implements all modules of the game system 2. For instance, on the server 1 side, the processing module 500 implements the game engine 10 and the video encoder 12. On the game system 2 side, the processing module 500 implements the video decoder 20 and the registration module 21. However, in another embodiment, independent processing module 500 can implement each module of the server 1 and of the game system 2 independently.

In a step 201, the processing module 500 of the game system 2 obtains the settings selected by the users. From these settings, the processing module 500 of the game system 2 obtains an identifier representative of a desired QoE. In an embodiment, the user selects directly an identifier representative of the desired QoE.

In a step 202, the processing module 500 of the game system 2 transmits the identifier to the server 1.

In a step 203, the processing module 500 of the server 1 receives the identifier representative of the desired QoE.

In a step 204, the processing module 500 of the server 1 obtains encoding parameters based on the identifier.

In a step 205, the processing module 500 of the server 1 tunes the video encoder so that it generates encoded video streams compliant with the identifier, i.e. compliant with the desired QoE.

From the step 205, the video encoder 12 encodes in a step 206 the pictures provided by the 3D graphics renderer 11 in encoded video streams compliant with the identifier.

In a step 207, the processing module 500 of the server 1 transmits the encoded video stream compliant with the identifier to the game system 2, i.e. to the decoder 20.

In a step 208, the processing module 500 (i.e. the video decoder 20 implemented by the processing module 500) of the game system 2 decodes the received encoded video stream.

In a step 209, the processing module 500 of the game system 2 transmits decoded pictures to the display system 55.

In an embodiment adapted to low delay applications wherein pictures are not generated live, the server 1 stores pre-encoded video streams compliant with all (or at least the most probable or the most requested) QoE. In that case, the processing module selects in the step 205 the pre-encoded video stream compliant with the quality of experience corresponding to the identifier and transmits the selected pre-encoded video stream.

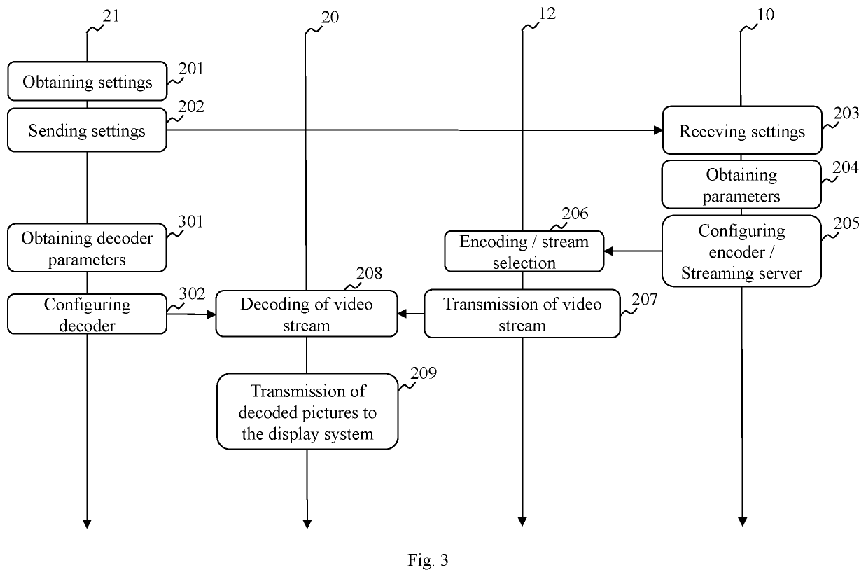

FIG. 3 depicts schematically a second embodiment of a method allowing fine tuning of a codec in a streaming application.

In the embodiment of FIG. 3, the identifier of the desired QoE is not only used to tune the encoding process (and the decoding process though the encoded video stream it receives) but also directly to tune the decoding process.

All steps of the method of FIG. 2 are kept in the method of FIG. 3. Two additional steps 301 and 302 are added.

In the step 301, the processing module 500 of the game system 2 obtains decoder parameters from the identifier of the desired QoE. For instance, a first value of the identifier induces decoder parameters indicating to decode only INTRA pictures or to skip some in-loop post filters, such as the SAO for example. A second value of the identifier induces decoder parameters leading to an application by the video decoder 20 of post-treatments to the decoded pictures. As can be seen, the identifier is used to tune the video decoder 20 so that the video decoder 20 skips some decoding processes specified in the encoded video stream: activate only the necessary decoding functions, according to the parameters set for desired QoE from the video encoder or the video decoder 20 adds decoding processes not specified in the encoded video stream, i.e. adds additional decoding processes in addition to the processes specified in the encoded video stream.

In the step 302, the processing module 500 of the game system 2 configures the video decoder based on the decoder parameters.

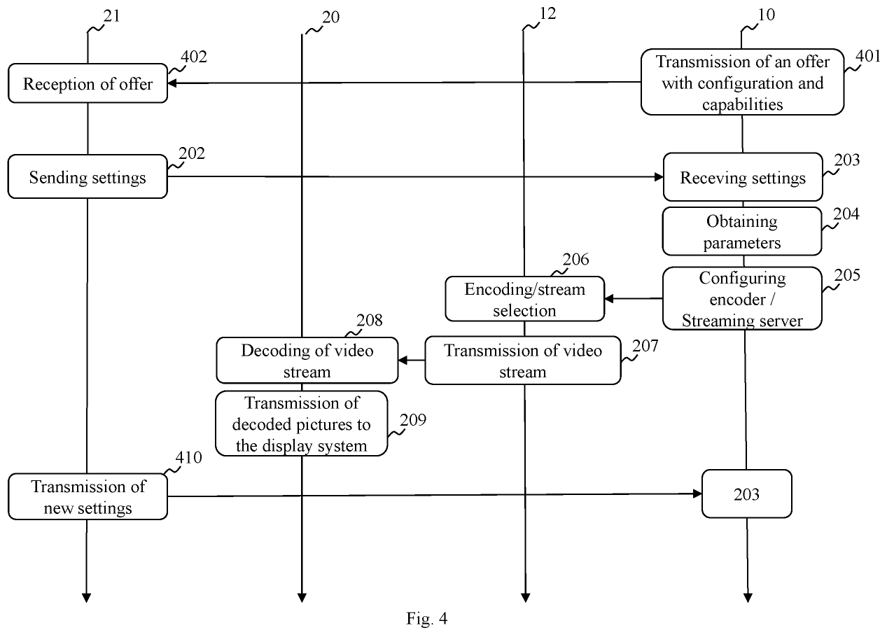

FIG. 4 depicts schematically a third embodiment of a method allowing fine tuning of a codec in a streaming application.

The method of FIG. 4 is another variation of the method of FIG. 2. Steps 202 to 209 are kept.

Step 201 is replaced by two steps 401 and 402 during which a capability exchange takes place.

In the step 401, the processing module 500 of the server 1 transmits an information representative of a set of encoding tools and/or configurations supported by the video encoder 12 to the game system 2.

In the step 402, the processing module 500 of the game system 2 receives this information and determines in function of this information a set of encoding tools that can be activated or deactivated. This set of encoding tools is then presented to the user which defines a desired QoE in function of this set.

Another feature of the method of FIG. 4 is the capability of updating the desired QoE, i.e. the capability of sending if needed a new identifier of a desired QoE.

Accordingly, in a step 410, the processing module 500 of the game system 2 transmits a new identifier to the server 1. The processing module 500 of the server 1 then executes step 203.

Until now, we have not described in detail what is represented by the identifier of the desired quality of experience. In the following, we describe several embodiments of data represented by the identifier.

In a first embodiment of data represented by an identifier, the identifier represents a profile of a video compression standard.

In certain application, such as cloud gaming, the content can vary greatly from a very graphic representation to a more natural look. However, the color space can be quite extended, and texture can be also quite rich. As such video coding tools were usually developed for natural contents they may not be as efficient as coding tools developed for computer graphics pictures and graphics. Therefore, is some embodiments, video coding tools could be complemented by tools developed for computer graphics pictures and graphics.

In the first embodiment, a new profile adapted to low delay streaming applications is defined. In the following, a profile, called Low Latency Graphic (LLG) profile, adapted to VVC is proposed. The LLG profile disables encoding tools with low coding performance and high computational cost. Similar LLG profiles could be defined for other video coding standards such as EVC, HEVC, AVC, VP9 and AV1.

Table TAB2 provides an example of definition of the LLG profile for VVC (called Main 10 LLG profile). Bitstreams conforming to the Main 10 LLG profile shall obey at least some of the following constraints:

TABLE 2
Main 10 LLG profile

```
● No VPS: Referenced SPSs shall have sps_video parameter_set_id
  equal to zero.
● Constraint Flags for everything that is not LDB (low delay B pictures)
  or LDP (low-delay P pictures) are set to zero.
  Flags that indicate the use of a coding tool employing at least one
  reference picture with a POC (Picture Order Count) higher than the
  POC of a picture being decoded are all set to zero.
  Examples of concerned coding tools:
    ◯ DMVR: Decoder Side Motion Vector Refinement;
    ◯ BDOF: Bi-Direction Optical Flow;
    ◯ SMVD: Symmetric Motion Vector Difference;
    ◯ CRA : Clean Random Access (A CRA picture does not use
      inter prediction in its decoding process, and could be the first
      picture in the bitstream in decoding order, or could appear
      later in the bitstream.).
● Constraints flags related to tools not attractive in terms of coding
  efficiency/decoding latency trade-off shall be set to zero.
    ◯ ALF: Adaptive Loop Filter;
    ◯ CCALF: Cross-Component Adaptive Loop Filter.
● Encoder side latency: tools needing significantly complex coding
  mode search shall be deactivated.
    ◯ No dependent quantization : Referenced SPSs shall have
      sps_dep_quant_enabled_flag equal to zero.
● Coding tools having poor compression efficiency in low-delay
  configuration shall be deactivated:
    ◯ ISP: Intra Sub-Partition.
    ◯ SAO: Sample Adaptive Offset
    ◯ LMCS: Luma Mapping with Chroma Scaling
    ◯ CIIP: Combined Intra Inter Prediction
    ◯ MRL: prediction with Multi-Reference Lines
    ◯ SbTMVP: Sub-block Temporal Motion Vector Prediction
    ◯ BCW: bi-prediction with Cu Weight
    ◯ PROF: Prediction Refinement with Optical Flow
● Referenced SPSs shall have ptl_multilayer_enabled_flag equal to “0”
  to indicate that only mono-layer video streams are allowed.
● Referenced SPSs shall have sps_chroma_format_idc equal to “0” or
  “1” to indicate that only monochrome and 4:2:0 are allowed.
● Referenced SPSs shall have sps_bitdepth_minus8 in the range of “0”
  to “2”, inclusive to limit the bitdepth of the luma and chroma values.
● Referenced SPSs shall have sps palette_enabled_flag equal to “0” or
  “1” specifying if the palette mode is allowed
  (sps palette_enabled_flag=1) or not allowed
  (sps_palette_enabled_flag=0).
```

In a second embodiment of data represented by an identifier, the identifier represents a group of constraint flags.

The below is an example of how constraint flags as described in VVC could relate to a user QoE and could be mapped to a user-friendly selection settings.

The following exemplary qualities of experience could be defined:
High visual quality with latency increase (HVQLI) when tools that are deactivated would increase the latency, but visual quality will improve (either by disabling that tool or by using alternative tool);
Fast (F): tools that are deactivated would decrease the encoding/decoding processing time, while impacting the visual quality. The deactivation of the tools may or may not induce a significant loss in compression gain;
Intermediate (I): tools that are deactivated would decrease the encoding/decoding processing time but less than the fast setting, while not impacting much the visual quality
Chroma (C): tools applying a specific processing to the chroma are deactivated. Only process derived from the luma are applied. Alternatively a grey level QoE could be defined in which only the luma component are coded/rendered.

Each of these identifier are associate to a group of constraint flags that allow to achieve this QoE. Table TAB3 associates a subset of the constraint flags defined in VVC to a QoE. Other constraint flags not mentioned in this table are considered as not impacted by any QoE that can be selected and the corresponding tools can be used freely. When only a subset of the QoE defined above is mentioned for a constraint flag, the tool corresponding to the constraint flag can be used freely for the QoE that are not mentioned.

TABLE 3

| | Quality of experience | Value of the constraint |
|---|---|---|
| | concerned by the | flag, Performence |
| Constraint flag | constraint flag | impact, and comments |
| gci_intra_only_constraint_flag | HVQLI, F, I, C | Shall be zero in all QoE |
| | | as Intra-only coding is |
| | | not used to ensure |
| | | proper latency. |
| gci_no_idr_constraint_flag | HVQLI | Set to zero in the |
| | | HVQLI QoE to allow |
| | | for an intra refresh |
| | | point. Set to “1” in other |
| | | QoE. |
| gci_no_cra_constraint_flag | HVQLI, F, I, C | Shall be set to one in all |
| | | QoE so that CRA is not |
| | | used and alternative |
| | | methods such as GDR |
| | | or RPR could be used |
| | | instead which should |
| | | have a lower latency. |
| gci_no_gdr_constraint_flag | HVQLI, F, I, C | Shall be set to zero in |
| | | all QoE for allowing |
| | | GDR in all conditions. |
| gci_no_palette_constraint_flag | F | Shall be set to “1” in F |
| | | QoE to deactivate the |
| | | palette mode. Loss in |
| | | visual quality |
| gci_no_isp_constraint_flag | F | Shall be set to “1” in F |
| | | QoE |
| gci_no_mrl_constraint flag | F | Shall be set to “1” in F |
| | | QoE |
| gci_no_mip_constraint_flag | F | Shall be set to “1” in F |
| | | QoE |
| gci_no_ref_pic_resampling_ | HVQLI | Shall be set to “1” in |
| constraint_flag | | the HVQLI QoE and |
| | | preference is given to |
| | | IDR, CRA, GDP |
| gci_no_bdof_constraint_flag | HVQLI, F, I, C | Shall be set to “1” for |
| | | all QoE |
| gci_no_smvd_constraint_flag | HVQLI, F, I, C | Shall be set to “1” for |
| | | all QoE |
| gci_no_dmvr_constraint_flag | HVQLI, F, I, C | Shall be set to “1” for |
| | | all QoE |
| gci_no_bcw_constraint_flag | HVQLI, F, I, C | Shall be set to zero in |
| | | HVQLI and set to “1” |
| | | in all other QoE |
| gci_no_ciip_constraint_flag | HVQLI, F, I, C | Shall be set to zero in |
| | | HVQLI and set to “1” |
| | | in all other QoE |
| gci_no_gpm_constraint_flag | HVQLI, F, I, C | Shall be set to “1” in all |
| | | QoE |
| gci_no_transform_skip_ | HVQLI, F, I, C | Shall be set to zero in |
| constraint_flag | | all QoE |
| gci_no_joint_cbcr_constraint_ | HVQLI, Color | Shall be set to zero |
| flag | | HQVLI and C QoE |
| gci_no_dep_quant_constraint_ | F, I | Shall be set to “1” in F |
| flag | | and I QoE |
| gci_no_sao_constraint flag | HVQLI, F, I, C | Shall be set to 1 |
| gci_no_alf_constraint_flag | F | Shall be set to 1 in F |
| | | QoE |
| gci_no_ccalf_constraint_flag | F | Shall be set to 1 in F |
| | | QoE |
| gci_no_lmcs_constraint_flag | HVQLI, F, I, C | shall be set to 1 in all |
| | | QoE |

In the table TAB3:
The QoE HVQLI is associated to a group of constraint flags comprising gci_no_Imcs_constraint_flag, gci_no_sao_constraint_flag, gci_no_joint_cbcr_constraint_flag, gci_no_transform_skip_constraint_flag, gci_no_gpm_constraint_flag, gci_no_ciip_constraint_flag, gci_no_bcw_constraint_flag, gci_no_dmvr_constraint_flag, gci_no_smvd_constraint_flag, constraint_flag, gci_no_bdof_constraint_flag, gci_no_gdr_constraint_flag, gci_no_cra_constraint_flag, gci_intra_only_constraint_flag.
The QoE F is associated to a group of constraint flags comprising gci_no_Imcs_constraint_flag, gci_no_sao_constraint_flag, gci_no_transform_skip_constraint_flag, gci_no_gpm_constraint_flag, gci_no_ciip_constraint_flag, gci_no_bcw_constraint_flag, gci_no_dmvr_constraint_flag, gci_no_smvd_constraint_flag, constraint_flag, gci_no_bdof_constraint_flag, gci_no_idr_constraint_flag gci_no_cra_constraint_flag, gci_intra_only_constraint_flag, gci_no_palette_constraint_flag, gci_no_isp_constraint_flag, gci_no_mrl_constraint_flag, gci_no_mip_constraint_flag, gci_no_dep_quant_constraint_flag, gci_no_alf_constraint_flag, gci_no_ccalf_constraint_flag,
The QoE I is associated to a group of constraint flags comprising gci_no_Imcs_constraint_flag, gci_no_sao_constraint_flag, gci_no_transform_skip_constraint_flag, gci_no_gpm_constraint_flag, gci_no_ciip_constraint_flag, gci_no_bcw_constraint_flag, gci_no_dmvr_constraint_flag, gci_no_smvd_constraint_flag, gci_no_bdof_constraint_flag, constraint_flag, gci_no_gdr_constraint_flag, gci_no_cra_constraint_flag, gci_intra_only_constraint_flag, gci_no_dep_quant_constraint_flag.
The QoE C is associated to a group of constraint flags comprising gci_no_Imcs_constraint_flag, gci_no_sao_constraint_flag, gci_no_joint_cbcr_constraint_flag, gci_no_transform_skip_constraint_flag, gci_no_gpm_constraint_flag, gci_no_ciip_constraint_flag, gci_no_bcw_constraint_flag, gci_no_dmvr_constraint_flag, gci_no_smvd_constraint_flag, constraint_flag, gci_no_bdof_constraint_flag, gci_no_gdr_constraint_flag, gci_no_cra_constraint_flag, gci_no_idr_constraint_flag, gci_intra_only_constraint_flag.

When a user selects a QoE, indirectly he selects a group of constraint flags, and values for the constraint flags in this set.

In a first variant of the first and second embodiment of data represented by an identifier, additional encoding decisions can be made on the server 1 side in function of the identifier. An encoding decision defines a particular implementation of the video encoder independently of the constraint flags and profiles.

For instance, if the F(fast) QoE is selected, the video encoder 12 doesn't use tools that require some iterative process (aka when parallel operations are not supported). An example is to prevent a use of a RDOQ (Rate Distortion Optimized Quantization) if not parallelizable.

If the HVQLI QoE is selected, the video encoder 12 performs additional operations to improve the subjective quality of the bitstream or the overall RD performances for example by applying a pre-processing.

In addition, an increased latency mode (for game with a slower pace or for video breaks in the game, such as video ads, intermission etc) can be used and achieved by increasing the GOP (Group Of Pictures) size to a value larger than one, and which depends on the trade-off between quality and latency desired. Increased GOP size would increase heavily the rate distortion performance of the video encoder.

In a second variant of the first and second embodiment of data represented by an identifier, additional decoding decisions can be made on the game system 2 side in function of the identifier. A decoding decision defines a particular implementation of the video decoder 20 independently of the constraint flags and profiles.

This second variant is compliant with the method of FIG. 3.

For instance, if the F(fast) QoE is selected, the processing module 500 of the game system 2 imposes to the video decoder 20 to reduce the frame rate of the decoded video, for instance by skipping the decoding of some pictures that are not used as reference pictures for temporal prediction of other pictures.

The selection of the HVQLI QoE leads to an application of a post-processing (such as a de-noising filter, contour improvement) on pictures outputted by the video decoder.

In an embodiment, the QoE identifier (such as HVQLI, F, I, C) is provided via a specific SEI message

An exemplary SEI message is provided:

TABLE 4

```
ue-qoe( payloadSize ) {
  ue_qoe_cancel_flag
  if( !ue_qoe_cancel_flag ) {
    ue_qoe_persistence_flag
    ue_qoe_type
}
```

ue_qoe_type identifies the type of the desired end-user QoE as specified in table TAB5. The value of ue_qoe_type shall be in the range of 0 to y, inclusive.

TABLE 5
ue_qoe_type values

| Value | Description |
|---|---|
| 0 | HVQLI |
| 1 | F |
| 2 | I |
| 3 | C |
| y | . . . |

If ue_qoe_type value-0 then all the constraint flags defined above are set to their corresponding value for HVQLI (idem for F when value is 1, I when value is 2, C when value is 3 . . . ).

In another embodiment, the mapping between QoE identifiers (such as HVQLI, F, I, C) and their corresponding set of constraint flags/encoding decisions/decoding decisions is provided out of band via a specific SEI message described in table TAB6.

TABLE 6

```
ue-qoe( payloadSize ) {
  ue_qoe_hvqli_flag
  if( ue_qoe_hvqli_flag ) {
    gci_no_lmcs_constraint_flag
    gci_no_sao_constraint_flag
.....
  ue_qoe_F_flag
  if( ue_qoe_F_flag ) {
    gci_no_isp_constraint_flag
.....
}
```

With all flags, being set according to above paragraphs, or containing only all flags that needs to be set to 1.

In another embodiment, the game system 2 receives in a SEI message a description of set of QoE that can be selected by the user.

When end to end latency is an important factor, some low delay applications, such as cloud gaming, use the Real-time Transport Protocol (RTP), which is designed for end-to-end, real-time transfer of streaming media over IP network. These applications require timely delivery of information and may tolerate some packet losses. RTP sessions are typically initiated between two or more endpoints using a signaling protocol. The Session Description Protocol (SDP) can be used to specify the parameters for the session and to describe the session, the timing and the media within the session. Note that even if some of the following embodiments are described as using RTP, RTP can be replaced by other transport protocols such as SRTP, webrtc, etc.

As seen in the method of FIGS. 2, 3 and 4, each method comprises a step 202 of sending an identifier of a desired QoE. In addition, the method of FIG. 4 comprises a phase of capability exchange with steps 401 and 402. Various protocols are adapted to execute these steps.

When a RTP (real-time Transport Protocol: RFC-1889) session is used to send a video stream, an information representative of a QoE desired by a client can be signaled as an extension of a Session Description Protocol (SDP: RFC 4566) mechanism such as the one defined in RTP/AVPF (RFC4585) SDPCapNeg (RFC 5939) Codec Control Message (RFC 5104).

The VVC RTP payload under definition (https://tools.ietf.org/html/draft-ietf-avtcore-rtp-vvc-07 #page-50) provides an SDP example as follow:

m=video 49170 RTP/AVP 98
a=rtpmap:98 H266/90000
a=fmtp:98 profile-id=1; sprop-vps=<video parameter sets data>

As the RTP payload will be fully specified, the line a=fmtp will include much more parameters. For example, in an embodiment, a parameter sprop-constraint-field=<constraint flag sets data> is introduced in the line a=fmtp. This parameter is used to convey any information representative of a constraint flag, constraint flags, groups of constraint flags or a profile such as the Main 10 LLG profile.

In a variant, the parameter sprop-constraint-field=<constraint flag sets data> is used for capability exchange. During the capability exchange, the server 1 specifies to the game system 2, with the parameter sprop-constraint-field=<constraint flag sets data>, the encoding tools that can be activated or deactivated by the user. In reply, the game system 2 specifies to the server 1, with the parameter sprop-constraint-field=<constraint flag sets data>, the identifier representative of the desired QoE, i.e. representative of the activated and deactivated encoding tools selected by the user.

As already mentioned this parameter sprop-constraint-field can include a list of constraint flags, or an identifier of a group of constraint flags corresponding to a desired QoE. As described by steps 203 and 204 in FIGS. 2-4, when receiving the identifier, the server 1 determines the constraint flags associated with this identifier and the values of these constraint flags and, as in the first variant of the first and the second embodiment of data represented by an identifier, an encoding decision where relevant (aka, application of a RDOQ, application of iterative processes, . . . ). In parallel, in the second variant of the first and the second embodiment of data represented by an identifier, the game system 2 determines a decoding decision allowing tuning the decoding process where relevant based on the identifier.

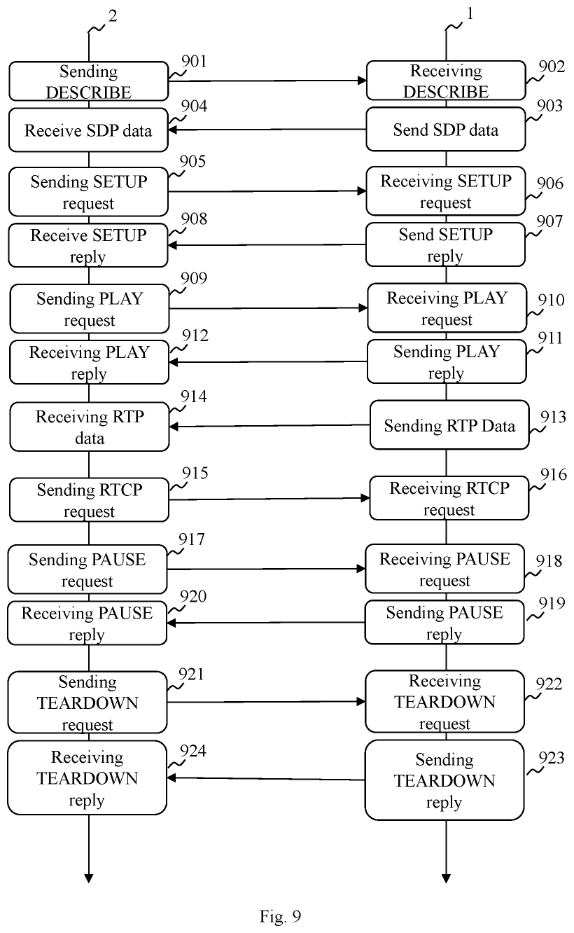

FIG. 9 illustrates a streaming session establishment process between a client and a server using a RTP/RTSP session-based streaming according to the an embodiment. Here, the client is the game system 2 and the server is the server 1.

In a step 901, the processing module 500 of the game system 2 sends a RTSP DESCRIBE request to the server 1. The RTSP DESCRIBE request allows retrieving a description of a content or media object identified by a request URL from a server. It may use an Accept header to specify description formats that the game system 2 understands.

In a step 902, the processing module 500 of the server 1 receives the RTSP DESCRIBE request.

In a step 903, the processing module 500 of the server 1 responds with a SDP message comprising a description of the requested content in SDP format. The new optional constraint flag sets data parameter is included in the SDP message to signal at least a support of parameters related to a control of encoding constraints but also encoding restriction information related to the requested content corresponding to different QoEs.

In a step 904, the processing module 500 of the game system 2 receives the SDP message comprising the parameter constraint flag sets data. In an embodiment, the parameter constraint flag sets data just informs the game system 2 that the server 1 supports parameters related to encoding constraints. In another embodiment the parameter constraint flag sets data comprises for example the syntax element ue_qoe_F_flag, and/or the syntax elements corresponding to QoE_F such as gci_no_isp_constraint_flag, gci_no_idr_constraint_flag, gci_no_dep_quant_constraint_flag, gci_no_alf_constraint_flag. Therefore, in step 904, the processing module 500 of the game system 2 receives information allowing controlling the encoding configuration matching with its desired QoE.

In a step 905, the processing module 500 of the game system 2 sends a RTSP SETUP request to the server 1. A RTSP SETUP request specifies the transport mechanism to be used for a streamed content. In addition, this RTSP SETUP request specifies an indication of the QoE expected by the game system 2 in terms of activated or inactivated encoding tools when decoding a stream corresponding to the requested content. For instance, the game system 2 requests the Fast(F) quality of experience, with respect to the most complex version of the requested content. As can be seen, in step 905, the game system 2 can request a stream compliant with an expected QoE_F which correspond to activated or deactivated encoding tools from the set

| | |
|---|---|
| gci_no_lmcs_constraint_flag, | gci_no_sao_constraint_flag, |
| gci_no_transform_skip_constraint_flag, | gci_no_gpm_constraint_flag, |
| gci_no_ciip_constraint_flag, | gci_no_bcw_constraint_flag, |

gci_no_dmvr_constraint_flag, gci_no_smvd_constraint_flag, constraint_flag,

| | |
|---|---|
| gci_no_bdof_constraint_flag, | gci_no_idr_constraint_flag |
| gci_no_gdr_constraint_flag, | gci_no_cra_constraint_flag, |
| gci_intra_only_constraint_flag, | gci_no_palette_constraint_flag, |
| gci_no_isp_constraint_flag, | gci_no_mrl_constraint_flag, |
| gci_no_mip_constraint_flag, | gci_no_dep_quant_constraint_flag, |

gci_no_alf_constraint_flag, gci_no_ccalf_constraint_flag..

In a variant, in step 905, the game system 2 can request an expected QoE and specify activated and deactivated encoding tools. For instance, the game system 2 requests a Fast QoE with respect to the most complex version of the requested content and request a version of the content wherein adaptive loop filters are deactivated.

One can note that, when the parameter constraint flag sets data indicates only to the game system 2 that the server 1 supports parameters related to a control of quality of experience (without specifying which parameters related to a control of QoE is supported), the game system 2 understand that any parameter is supported for example any parameter in a “HVQLI” set comprising constraint flags such as

| | |
|---|---|
| gci_no_lmcs_constraint_flag, | gci_no_sao_constraint_flag, |
| gci_no_joint_cbcr_constraint_flag, | gci_no_transform_skip_constraint_flag, |
| gci_no_gpm_constraint_flag, | gci_no_ciip_constraint_flag, |
| gci_no_bcw_constraint_flag, | gci_no_dmvr_constraint_flag, |

gci_no_smvd_constraint_flag, constraint_flag, gci_no_bdof_constraint_flag,
gci_no_gdr_constraint_flag, gci_no_cra_constraint_flag, gci_no_idr_constraint_flag,
gci_intra_only_constraint_flag.

In a step 906, the processing module 500 of the server 1 receives the RTSP SETUP request.

In a step 907, the processing module 500 of the server 1 sends a RTSP SETUP reply comprising transport parameters and a session identifier selected by the processing module of the server 1.

In a step 908, the processing module 500 of the game system 2 receives the RTSP SETUP reply.

In a step 909, the processing module 500 of the game system 2 sends a RTSP PLAY request. A RTSP PLAY request tells the server 1 to start sending data corresponding to a version of the requested content via the mechanism specified in the RTSP SETUP request.

In a step 910, the processing module 500 of the server 1 receives the RTSP PLAY request.

In a step 911, the processing module 500 of the server 1 sends a RTSP PLAY reply confirming the start of the sending of the data.

In a step 912, the processing module 500 of the game system 2 receives the RTSP PLAY reply confirming the start of the sending of the data.

In step 913, the sending of the data by the processing module 500 of the server 1 starts using a RTP session. The sent data corresponds to a version of the content corresponding to the QoE or the characteristics in terms of activated and deactivated encoding tools expected by the game system and specified by in the RTSP SETUP request sent in step 905.

In a step 914, the game system 2 starts receiving the data.

In a step 915, during the transmission of the data, the processing module 500 of the game system 2 sends regularly RTCP (Real-Time Control Protocol) requests to provide to the server 1 information on the ongoing RTP session. Reception of RTCP requests by the server 1 is represented by a step 916. The RTCP request can contains a different QoE level (HVQLI, Fast), or can contain codec control messages such as RRPR, or GDRR (RRPR and GDRR control messages are explained later in this document).

In a step 917, the processing module 500 of the game system 2 sends a RTSP PAUSE request to the server 1. A RTSP PAUSE request causes the stream delivery to be interrupted temporarily.

In a step 918, the processing module 500 of the server 1 receives the RTSP PAUSE request.

In a step 919, the processing module 500 of the server 1 sends a RTSP PAUSE reply confirming the pause to the game system 2.

In a step 920, the processing module 500 of the game system 2 receives the RTSP PAUSE reply.

In a step 921, the processing module 500 of the game system 2 sends a RTSP TEARDOWN request to the server 1. A RTSP TEARDOWN request stops the stream delivery, freeing the resources associated with it.

In a step 922, the processing module 500 of the server 1 receives the RTSP TEARDOWN request.

In a step 923, the processing module 500 of the server 1 sends a RTSP TEARDOWN reply confirming the stop to the game system 2.

In a step 924, the processing module 500 of the game system 2 receives the RTSP TEARDOWN reply.

One can note that, during an ongoing streaming session, each time the game system 2 wants to modify the QoE of the requested content, it can loop back to step 905 and send a new RTSP SETUP request to the server 1 comprising new QoE requirements.

Alternatively, or in addition to the parameter sprop-constraint-field, in an embodiment, SDP attributes ACAP (Attribute CAPability) and SDP attributes PCFG (Potential ConFiGuration) as defined in RFC 5939: Session Description Protocol (SDP) Capability Negotiation can be included in an offer/answer to indicate that which capabilities or configurations are supported. An ACAP attribute defines how to list an attribute name and its associated value (if any) as a capability. A PCFG attribute lists potential configurations supported.

For instance, the following attributes ACAP for encoding setting (ES) and attributes PCFG are included in an offer provided via SDP:

m=video 49170 RTP/AVP 98
a=rtpmap:98 H266/90000
a=tcap:1 RTP/SAVPF
a= acap:1 ES: HVQLI
a=acap:2 ES: Fast
a=pcfg:1 t:1 a:2
a=pcfg:8 a:1

in this example, the offer proposes a RTP/AVP (RFC 3551: RTP Profile for Audio and Video Conferences with Minimal Control) session on the m line and one transport option tcap with secure RTP/SAVP (Real-time Transport Protocol/Secure Audio Video Profile). The offer proposes two potential attribute capabilities (acap: 1 and acap: 2) with Encoder capabilities to HVQLI and FAST. The preferred potential configuration is indicated by pcfg: 1 with the secured transport (t: 1) and the ES Fast (a: 2). The least favored potential configuration is indicated by pcfg: 8 with ES HVQLI (a: 1).

In the above embodiments, the codec was controlled mainly based on an identifier representative of a profile or of constraint flags or groups of constraint flags. This identifier can be also used to control features of a codec that cannot be controlled by a profile or constraint flags.

Other solution exists to control a codec. For instance, in the document RFC5104 (https://tools.ietf.org/html/rfc5104) a set of codec control messages are defined, some of which being included in the HEVC RTP RFC and in the VVC RTP RFC. Notably, these control messages defines a FIR (Full Intra Request) Command. When a FIR command is provided to an encoder, the encoder is expected to send an instantaneous decoding refresh (IDR) picture as soon as possible. An IDR picture is a coded picture in which all slices are I slices. When decoding an IDR picture, the decoding process marks all reference pictures as “unused for reference” immediately after decoding the IDR picture. Upon reception of a FIR command, a sender must send an IDR picture. One limitation of an IDR picture is that its transmission generates a temporary high peak of bitrate that is difficult to manage in streaming applications.

In VVC, a Gradual Decoder Refresh (GDR) function is normatively defined and allows for creating a progressive recovery point by sending columns of intra coded blocks. It is hence beneficial to define a new codec control message to provide for more flexibility than the FIR command and allowing obtaining a smoother variation of bitrate than when sending an IDR picture.

In accordance with section 7 of document RFC5104 which defines SDP procedures for indicating and negotiating support for codec control messages (CCM) in SDP, a Gradual Decoder Refresh request (GDRR) can be defined as follow:

rtcp-fb-ccm-param =/ SP “GDRR” ; Gradual Decoder Refresh Request

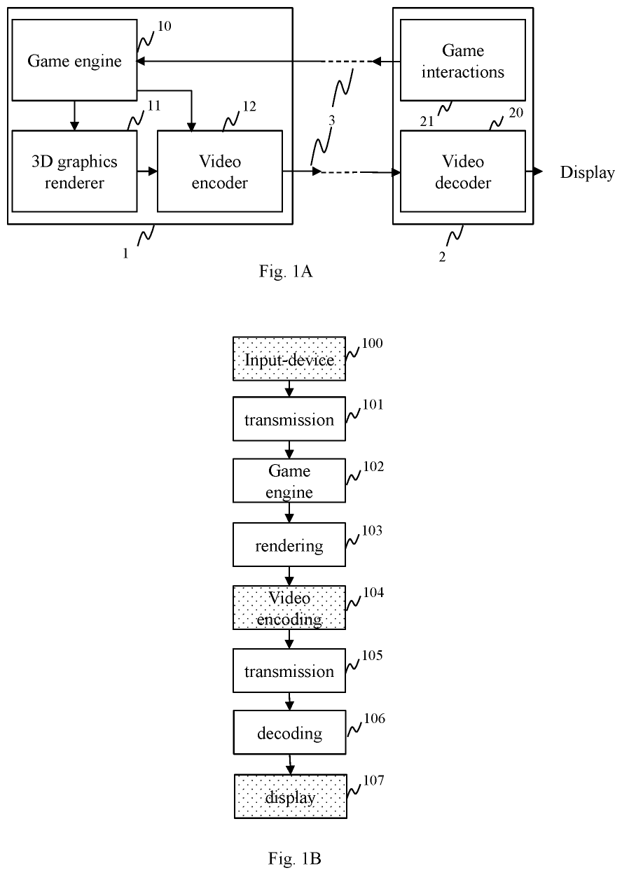

The purpose of the GDRR command is to force an encoder to send a gradual decoder refresh point as soon as possible. In the example of FIGS. 1-4, upon reception of a GDRR command, the server 1 MUST start sending a GDR point.

RFC 5104 states that for certain use-cases “Using the FIR command to recover from errors is explicitly disallowed, and instead the PLI message defined in AVPF [RFC4585] should be used. The PLI message reports lost pictures and has been included in AVPF for precisely that purpose.”

However the sending of a GDR command could be done in advance of a picture loss or a slice loss indication (for example: upon monitoring of bandwidth congestion buildup) and would still be allowed for other use-cases. In addition, RFC 4585 states that receipt of a PLI message, typically trigger the sending of full intra-pictures, while the objective is precisely to allow for progressive refresh and not sending a full Intra-picture.

As specified by RFC 4585, Payload-Specific feedback (PSBF) messages are identified by the RTCP packet type value PSFB. The GDRR message is identified by RTCP packet type value PT=PSFB and FMT=xxx. A value will need to be attributed to the GDRR FMT.

In VVC, RPR is defined and can be advantageously used to address some bandwidth or congestion issues. AOM AV1 have a similar function and the proposed command would apply to both codecs.

In an embodiment, in accordance with section 7 of RFC5104, a RPR request (RRPR) is defined as follow:

rtcp-fb-ccm-param =/ SP “RRPR” ; Reference Picture Resampling Request

The purpose of the RRPR request is to instruct an encoder to send a picture with a lower spatial resolution as soon as possible. In the example of FIGS. 1-4, upon reception of an RRPR, the server 1 must send a resampled picture. When no additional parameters are sent, the encoder/server is free to decide which spatial resolution to send. Additional parameters, e.g. in the FCI (Feedback Control Information) field, can be used to request a horizontal or vertical scaling, or an indicator for an incremental down/upscaling size, or a desired down/upscaling size.

As specified by section 6.1 of RFC 4585, Payload-Specific feedback messages are identified by the RTCP packet type value PSFB. The GDRR message is identified by RTCP packet type value PT-PSFB and FMT=xxx. A value will need to be attributed to that GDRR FMT.

In an example, we extend an example in section 7.3 of RFC 5104 with support for RRPR and GDRR capability exchange as part of the Offer/Answer for the codec control messages, which include an audio (e.g. G.711) and video (H.263) codecs. The offerer wishes to support “tstr (Temporal Spatial Trade-off)”, “fir (Full Intra Request)”, “gdrr” and “rrpr”. The offered SDP is:

```
-----------> Offer
  v=0
  o=alice 3203093520 3203093520 IN IP4 host.example.com
  s=Offer/Answer
  c=IN IP4 192.0.2.124
  m=audio 49170 RTP/AVP 0
  a=rtpmap:0 PCMU/8000
  m=video 51372 RTP/AVPF 98
  a=rtpmap:98 H263-1998/90000
  a=rtcp-fb:98 ccm tstr
  a=rtcp-fb:98 ccm fir
  a=rtcp-fb:* ccm tmmbr smaxpr=120
  a=rtcp-fb:98 ccm gdrr
  a=rtcp-fb:98 ccm rrpr
```

The answerer wishes to support only the GDRR messages as part of the additional capabilities and the answered SDP is:

```
<---------------- Answer
  v=0
  o=alice 3203093520 3203093524 IN IP4 otherhost.example.com
  s=Offer/Answer
  c=IN IP4 192.0.2.37
  m=audio 47190 RTP/AVP 0
  a=rtpmap:0 PCMU/8000
  m=video 53273 RTP/AVPF 98
  a=rtpmap:98 H263-1998/90000
  a=rtcp-fb:98 ccm gdrr
```

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof.
A TV, game console, cell phone, tablet, or other electronic device that performs at least one of the embodiments described.
A TV, game console, cell phone, tablet, or other electronic device that performs at least one of the embodiments described, and that displays (e.g. using a monitor, screen, or other type of display) a resulting picture.
A TV, game console, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.

Amendments to and listing of the claims:

1. A method, in a client device, comprising:
selecting an identifier of a user quality of experience, the identifier being associated with a group of constraint flag values, each constraint flag value of the group indicating whether to activate or deactivate an associated encoding tool of a video encoder;
transmitting the identifier to a server; and,
receiving, from the server a video data encoded with encoding tools activated or deactivated responsive to the group of constraint flag values associated with the transmitted identifier.

2. The method according to claim 1, wherein the identifier is used to define a decoding decision allowing tuning a video decoder so that the video decoder skips at least one decoding process specified in the video data or the video decoder adds at least one additional decoding process to decoding processes specified in the video data.

3. (canceled)

4. The method of claim 3, wherein selecting an identifier comprises selecting the identifier is after a phase of capability exchange with the server comprising a reception from the server of a session description protocol message specifying encoding tools that can be activated or deactivated or a set of qualities of experience that can be selected.

5. The method of claim 1, wherein, before selecting the identifier, the method comprises obtaining a description of a set of qualities of experience that can be selected in a supplemental enhancement information (SEI) message.

6. (canceled)

7. A method, in a server device, comprising:
receiving, from a remote system, an identifier of a user quality of experience, the identifier being associated with a group of constraint flags values, each constraint flag value of the group indicating whether to activate or deactivate an associated encoding tool of a video encoder;
encoding video data with encoding tools activated or deactivated responsive to the group of constraint flag values associated with the received identifier; and,
transmitting the encoded video data to the remote system.

8. The method according to claim 7, wherein the video data is encoded by a video encoder tuned based on the identifier.

9. The method of claim 8, wherein a tuning of the video encoder comprises activating or deactivating encoding tools associated with the group of constraint flags in function of the constraint flag values specified by the identifier.

10. The method according to claim 7, wherein the identifier is used to specify at least one encoding decision allowing defining a particular implementation of a video encoder independently of the constraint flag values and any profile.

11. (canceled)

12. The method of claim 7, wherein
receiving an identifier comprises receiving the identifier is after a phase of capability exchange with the remote system comprising a transmission to the remote system of a session description protocol message specifying encoding tools that can be activated or deactivated or a set of qualities of experience that can be selected.

13. The method of claim 7, wherein,
before receiving the identifier, the method comprises transmitting to the remote system a description of a set of qualities of experience that can be selected in a supplemental enhancement information (SEI) message.

14-15. (canceled)

16. A device comprising an electronic circuitry adapted for:
selecting an identifier of a user quality of experience, the identifier being associated with a group of constraint flag values, each constraint flag value of the group indicating whether to activate or deactivate an associated encoding tool of a video encoder;
transmitting the identifier to a server; and,
receiving, from the server, video data encoded with encoding tools activated or deactivated responsive to the group of constraint flag values associated with the transmitted identifier.

17. The device according to claim 16, wherein the identifier is used to define a decoding decision allowing tuning a video decoder so that the video decoder skips at least one decoding process specified in the video data or the video decoder adds at least one additional decoding process to decoding processes specified in the video data.

18. (canceled)

19. The device of claim 18, wherein the electronic circuitry being configured for selecting an identifier comprises the electronic circuitry being configured for selecting the identifier is after a phase of capability exchange with the server comprising a reception from the server of a session description protocol message specifying encoding tools that can be activated or deactivated or a set of qualities of experience that can be selected.

20. The device of claim 16, wherein the electronic circuitry is adapted for obtaining a description of a set of qualities of experience that can be selected in a supplemental enhancement information (SEI) message before obtaining the identifier.

21. (canceled)

22. A device comprising an electronic circuitry adapted for:
receiving, from a remote system, an identifier of a user quality of experience, the identifier being associated with a group of constraint flag values, each constraint flag value of the group indicating whether to activate or deactivate an associated encoding tool of a video encoder;
encoding video data with encoding tools activated or deactivated responsive to the group of constraint flag values associated with the received identifier; and,
transmitting the encoded video data to the remote system.

23. The device according to claim 22, wherein encoding video data comprises encoding the video data by a video encoder tuned based on the identifier.

24. The device of claim 23, wherein a tuning of the video encoder comprises activating or deactivating encoding tools associated with the group of constraint flags in function of the constraint flag values specified by the identifier.

25. The device according to claim 22, wherein the identifier is used to specify at least one encoding decision allowing defining a particular implementation of a video encoder independently of the constraint flag values and any profile.

26. (canceled)

27. The device of claim 22, wherein the electronic circuitry being configured for receiving an identifier comprises the electronic circuitry being configured for receiving the identifier is after a phase of capability exchange with the remote system comprising a transmission to the remote system of a session description protocol message specifying encoding tools that can be activated or deactivated or a set of qualities of experience that can be selected.

28. The device of claim 22, wherein the electronic circuitry is configured for transmitting to the remote system a description of a set of qualities of experience that can be selected in a SEI message before receiving the identifier.

29-31. (canceled)
